(19) United States
(12) Patent Application Publication
(10) Pub. No.: US 2024/0386061 A1
(43) Pub. Date: Nov. 21, 2024

(54) SYSTEM AND METHODS FOR APPLIED MACHINE LEARNING FOR CONTEMPORANEOUS PROSPECTING FOR SALES

(71) Applicant: Super Truth, Inc., Wayne, PA (US)

(72) Inventors: Robert Paul Hill, IV, Wayne, PA (US); Jason Alan Snyder, Ridgewood, NJ (US); Jason Isla, Lyndhurst, OH (US); Elizabeth Young, West Chester, PA (US); Nicholas John Virag, Brooklyn, NY (US)

(73) Assignee: Super Truth, Inc., Wayne, PA (US)

(21) Appl. No.: 18/669,341

(22) Filed: May 20, 2024

Related U.S. Application Data
(60) Provisional application No. 63/467,589, filed on May 18, 2023.

(51) Int. Cl. G06F 16/9035

(52) U.S. Cl. CPC G06F 16/9035

(57) ABSTRACT

A system and method for sharing and management of first-party data while enabling synchronicity with third-party systems is provided herein. The method includes the steps of receiving a client's information, receiving an input from the client, extracting features from the input, assessing the extracted features utilizing a neural network, and generating a report for the client. The system may utilize a database customized using first-party information to assess the extracted features specific to the client. This information may be utilized to generate the report tailored to the client's criteria, that may be further refined through input received from the client.

### CLAIM OF PRIORITY

This application claims priority to U.S. Provisional Patent Application No. 63/467,589 filed May 18, 2023, the contents of which are incorporated herein by reference.

### FIELD OF THE PRESENT DISCLOSURE

The present disclosure is directed to a computer system, and a process carried out by such a system, for preventing data decay. More specifically, the present disclosure is directed to a computing system and computer-implemented method for automated data quality checks by managing datasets to ensure accuracy over time.

### INTRODUCTION

With the advent of the internet, businesses have had more access to data than ever before, and the utilization of data has become increasingly significant.

An important aspect of businesses utilizing data is the ability to manage its decay and gradual decline in quality over time to prevent lagging behind in an ever-evolving landscape. As data ages, its accuracy and relevancy steadily decrease, leading to inefficient business practices, which hampers a business's ability to quickly adapt to changing circumstances.

Managing obsolete data can be difficult and poses significant problems to businesses seeking to optimize their operations. Automating data quality checks with machine learning allows a business to quickly identify which datasets are obsolete and require updating. Ensuring high quality, up to date, data prevents businesses from making decisions on outdated information, ultimately leading to improved performance.

Accordingly, it would be desirable to provide systems and methods configured to keep datasets relevant and accurate by streamlining processes for assessing data.

### SUMMARY

Disclosed herein are systems and methods for applied machine learning for contemporaneous data prospecting. More particularly, computing systems and computer-implemented methods for improving the sharing and management of first-party data while enabling synchronicity with third-party systems.

The method may comprise the steps of receiving a client's information, receiving an input from the client, extracting features from the input, assessing the extracted features utilizing a neural network, and generating a report for the client.

It is contemplated that the system may be customized to each client, such that the neural network used to assess the input is trained and/or fine-tuned accordingly to the client. In one embodiment, the neural network may be trained according to first-party data received as the input. Training the neural network according to the first-party data may, in an embodiment, generate a customized dataset for the client according to client specific criteria. In some embodiments, a pre-existing neural network may be utilized, and the system may fine-tune the existing neural network according to the client specific criteria. This may include specific parameters, studies, papers, research, or other criteria that the client may desire. By training and/or fine-tuning the neural network according to the first-party data, each client may determine their source of truth that is relevant, which may permit customized analysis and assessment of client data. It is contemplated that this may improve the handling of data.

The system may receive an input from the client corresponding to data to be analyzed. In other embodiments, features may be extracted from the input. These features may correspond to parameters specified by the user and/or the system. The extracted features may be run through the neural network to assess the input. Assessing the input may comprise any removing empty or irrelevant data, normalizing the input to local and/or global criteria, and cleaning the data.

It is contemplated that the aforementioned embodiments may be utilized individually or in conjunction with each other.

The report may be generated by the system to summarize an initial assessment of the data following analysis with the neural network. Following the report being generated, further refinement may occur. This refinement may comprise receiving an input from the client. In an embodiment, the refinement may comprise generating and displaying a graphical representation of the data. The graphical representation may comprise any of a graph, chart, diagram, infographic, plot, illustration, or other graphical representation.

In a further embodiment, the refinement may comprise receiving an input from the client. The input may correspond to the report and may permit interaction. This interaction may, in some embodiments, comprise interrogating the report. In such an embodiment, the system may comprise a chatbot or other user interface to permit the user to interact with the report. An input received by the chatbot or other user interface may, in some instances, result in a change to the report.

It is an object of the present disclosure to provide a system and method for customized learning algorithms according to the criteria of the user.

It is another object of the present disclosure to provide a system and method for secure data storage and organizational practices, that may, in some embodiments, be utilized for confidential data.

It is a further object of the present disclosure to improve the sharing of data.

It is yet another object of the present disclosure to permit streamlined management of data while enabling synchronicity with third-party systems.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates a block diagram of a distributed computer system that can implement one or more aspects of the present disclosure.

FIG. 2 illustrates a block diagram of an electronic device that can implement one or more aspects of the present disclosure.

FIG. 3 illustrates a diagram of an embodiment of a neural network architecture.

FIG. 4 illustrates a diagram of an embodiment of a Long Short-Term Memory (LSTM) architecture.

FIG. 5 illustrates a diagram of an embodiment of a Recurrent Neural Network architecture.

FIG. 6 illustrates a flowchart of one embodiment of the method.

FIG. 7A illustrates a diagram of an embodiment of a date refinement module.

FIG. 7B illustrates a diagram of another embodiment of a data refinement module.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

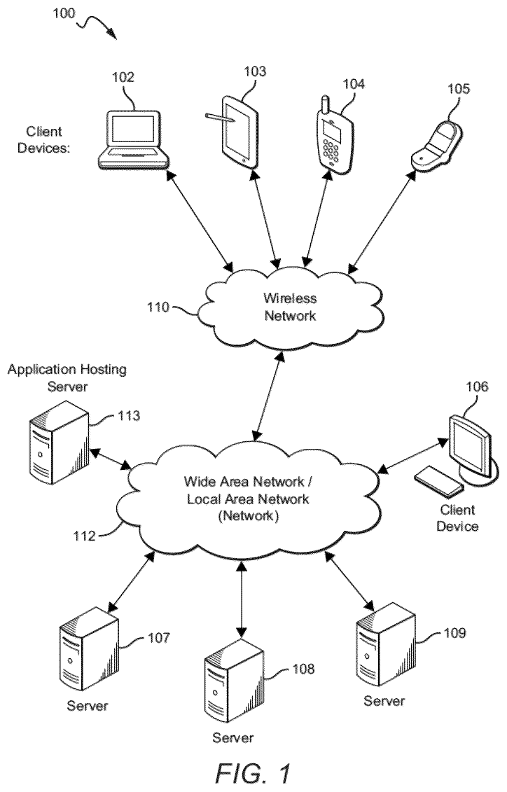

FIG. 1 illustrates components of one embodiment of an environment in which aspects of the present disclosure may be practiced. Not all of the components may be required to practice one or more aspects of the present disclosure, and variations in the arrangement and type of the components may be made without departing from the spirit or scope of the present disclosure. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various of the client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

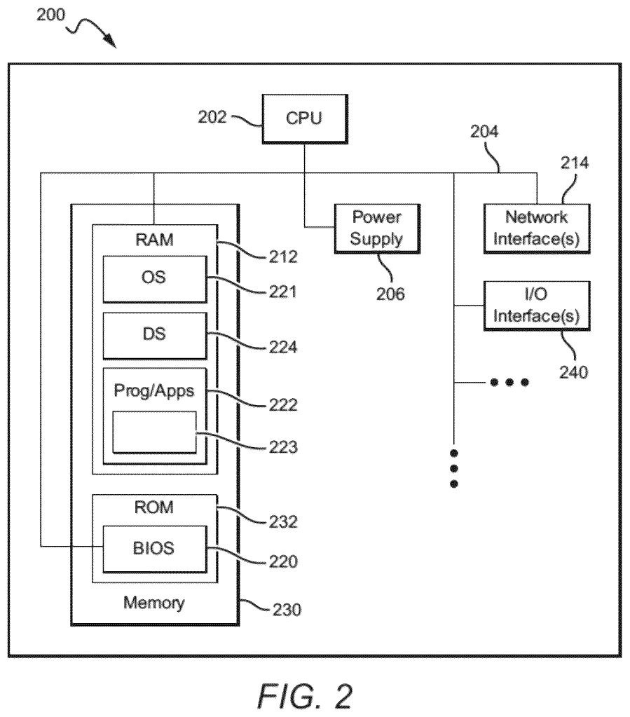

FIG. 2 illustrates a block diagram of an electronic device 200 that can implement one or more aspects of an apparatus, system and method for validating and correcting user information (the “Engine”) according to one or more aspects of the present disclosure. Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the present disclosure. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can case processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present disclosure include apparatuses, systems, and methods implementing the Engine. Embodiments of the present disclosure may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

The present disclosure relates to systems and methods for verifying and correcting information entered by a user.

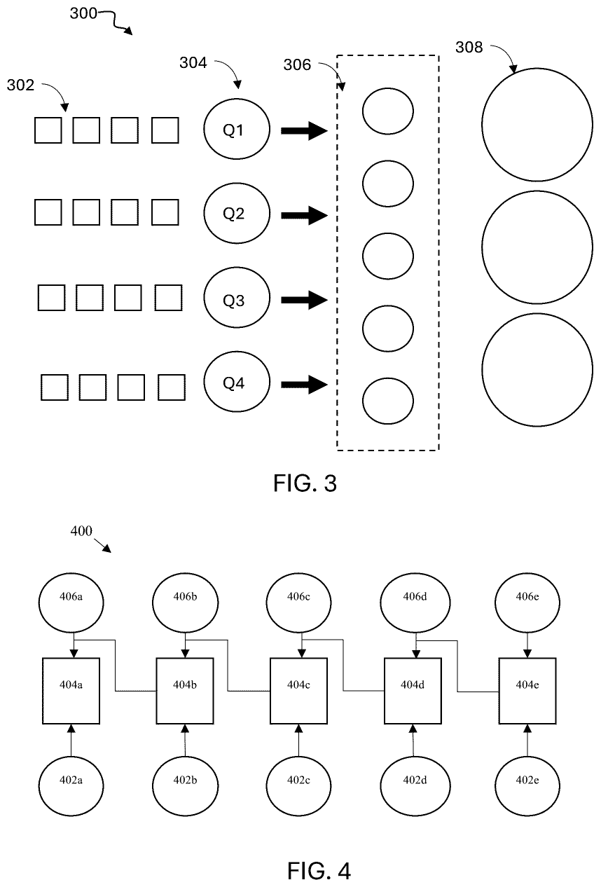

FIG. 3 illustrates the structure of a neural network 300 that can implement aspects of the present disclosure. In an embodiment, a user enters extracted features 302 from the user's electronic device, wherein the user's electronic device is configured to receive such extracted features 302. The user's electronic device may include a desktop computer, laptop computer, smart phone, wearable device or other electronic device as disclosed herein. The user may enter extracted features 302 using a physical keyboard such as a mechanical keyboard. Alternatively, the user may enter extracted features 302 using a digital keyboard. If the user's electronic device is a touchscreen device, the user may enter extracted features 302 by pressing digital keyboard keys displayed on a screen of the electronic device with the user's finger. Alternatively, if the electronic device is not a touchscreen device, the user may enter extracted features 302 by either clicking virtual keyboard keys using a mouse, or by entering the extracted features by pressing keys of a physical keyboard. Other embodiments of the electronic device may utilize different means to receive the extracted features 302, any of which may be utilized.

In one embodiment, the system may be utilized for the processing of medical information. In such an embodiment, the extracted features 302 may extracted from any of patient records, health encounter records, and lab results. The extracted features 302 may, in some embodiments, be categorized into various classifications. The classifications may be determined locally, according to first-party data, or according to global and/or third-party data. In some embodiments, the extracted features 302 is classified locally and may be exported according to industry standards. It is contemplated that exporting the extracted features 302 according to industry standards may enable synchronicity between third-party systems, thus improving the sharing of data between platforms. The data may be classified in any manner and the aforementioned are provided as non-limiting examples only.

In one embodiment, the system may normalize the inputs such that the extracted features 302 may be consistent. For example, the system may normalize extracted features comprising a shared characteristic. By normalizing the extracted features 302 according to shared characteristics, data may be properly characterized despite inconsistencies. This may permit a more robust, and thus more accurate, comparison of data within the database.

In an embodiment, the system may be configured to identify characteristics of the extracted features 302. In one embodiment, the system may identify an absence of an extracted feature. The absence of the extracted feature 302 may be identified, for example, when the extracted feature 302 is missing from the input. For example, when a form or other report is received by the system, a lack of information in a section may indicate the absence of extracted information 302. In another example, the input may comprise a plurality of related information, such as lab data, and an inconsistency between fields in the related information may correspond to the absence of extracted information 302.

Still further, the system may identify whether the extracted information 302 comprises suspicious data. The suspicious data may correspond to data that is inconsistent with and/or unlikely. For example, the system may detect outliers or unlikely values for specific demographics. The system may determine whether the data is inconsistent through comparison with a local and/or global database. Indeed, the database may be determined according to parameters customized by the client. Moreover, in some embodiments, the local database may be generated according to the neural network 300.

The user's extracted features 302 may be entered into an input layer 304 of the neural network. As a non-limiting example, Q1 through Q4 represent input layers 304 of the simple neural network 300. The extracted features 302 of the input layers 304 may be processed, analyzed, or categorized prior to being passed to the next layer.

A hidden layer 306 may receive the processed, analyzed, or categorized information, wherein the information may be further processed, analyzed, or categorized before the information is passed to the next layer. The information from the hidden layers 306 may be received by an output layer 308, wherein the output layers 308 may yield a final result of the information processed, analyzed, or categorized.

The neural network 300, as shown in FIG. 3, may be utilized to label data on various metrics (i.e., time to covert). Moreover, the labeled data may be organized into a ranking system. When the data is labeled, a supervised learning algorithm may be used to train a classifier. The systems and methods as described herein may be tested once the classifier is trained. After the systems and methods have been trained, new inputs may be sorted into distinct groupings (i.e., “good outputs” and “bad outputs”). For example, the distinct grouping may comprise “good outputs” and “bad outputs” wherein good outputs are outputs that are ranked highly, while bad outputs are ranked poorly. As a result, the systems and methods may classify novel input data.

In one embodiment, the supervised learning algorithm may be a named entity recognition (NER) model to categorize entities in similarly structured inputs. The NER model may be utilized for entity recognition, for example, the recognition of names, organizations, addresses, dates, diseases, numerical values, policy information, and lab tests, among others. In some embodiments, the NER model may comprise a set of features to categorize the entities. The NER model may be trained according to a plurality of annotated training data that comprises entities which are pre-labeled with a corresponding category.

The NER model may be pre-trained and may not require training. Instead, known and/or pretrained NER models may be utilized. However, in other embodiments the NER model may be trained according to the parameters of the client and/or the parameters of a specific task. The NER model may be further validated to demonstrate efficacy. The NER model may be constructed using techniques such as hidden Markov models, maximum entropy models, log linear models, conditional random fields (CRF), or other similar models.

In one embodiment, the NER model may apply grammar models and/or lexical information to identify entities. For example, the NER model may parse the input to tag or otherwise identify any of words according to their type/sematic meaning to identify the corresponding entity.

In a further embodiment, k-means clustering may be utilized. The k-means clustering may comprise at least one feature to be extracted and a number of centroids to cluster the data. Any number of features and centroids may be utilized and may, in some embodiments, be specific to the use of the system.

In one embodiment, training may be conducted upon receiving new data. This new data may be received as the input or may be otherwise received by the system. In an embodiment, the k-means clustering may be automatically trained as data is received. Features from the new data may be extracted and may be clustered.

In an embodiment, the training is conducted periodically. For example, the training may be conducted at regular intervals, such as, daily, weekly, quarterly, or annually. Of course, any period of time may be utilized and the aforementioned are provided as non-limiting examples. In another embodiment, the training may be triggered manually. For example, the NER model may be trained when a request to train the model is received. In some embodiments, training may be limited to instances where a pre-existing model does not support the features to be extracted. Of course, training may occur at any time or upon receiving specific data.

In some embodiments, the model may be a retriever model for a retriever-reader-generator (RAG) knowledge base that may be pre-trained. For example, the retriever model may be pre-trained large language model (LLM) for performing sematic search tasks. Of course, other LLMs may be utilized and the aforementioned are provided as non-limiting examples.

In one embodiment, the LLM may be utilized for the chatbot to understand inputs and respond to received prompts. Of course, other language models, such as chat completion models, may be utilized. In some embodiments, the LLM may utilize first-party and/or third-party information to interact with the client. It is contemplated that the use of first-party information and/or a knowledge base may tailor the chatbot interaction with the client, permitting improved responses.

FIG. 4 illustrates the structure of a Long Short-Term Memory (LSTM) based recurrent neural network 400. As a non-limiting example, the user may enter extracted features 302 into a first input layer 402a of the LSTM based recurrent neural network 400. The extracted features 302 from the first input layer 402a may be processed, analyzed, or categorized before being sent to a first hidden layer 404a. The first hidden layer 404a may be recurrent neural network (RNN) or other neural network architecture. The use of an RNN may generate connections between input layers, permitting the LSTM to respond to an ordered combination of extracted features 302.

Next, the processed, analyzed, or categorized extracted features 302 may be received by the first hidden layer 404a, wherein the extracted features 302 may be further processed, analyzed, or categorized before being sent to a first output layer 406a.

The first output layer 406a may receive the extracted features 302 from the first hidden layer 404a, wherein the first output layer 406a may produce a final result of the processed, analyzed, or categorized extracted features 302.

The user may enter extracted features 302 into a second input layer 402b of the LSTM based recurrent neural network 400. The extracted features 302 from the second input layer 402b may be processed, analyzed, or categorized before being sent to a second hidden layer 404b.

Next, the processed, analyzed, or categorized extracted features may be received by the second hidden layer 404b, which may consider the final result of the first output layer 406a, wherein the second hidden layer 404b may further process, analyze, or categorize the extracted features 302 from the second input. Further, a second output 406b may receive the further processed, analyzed, or categorized extracted features from the second hidden layer 404b, wherein the second output layer 406b may produce a final result of the processed, analyzed, or categorized extracted features. It is contemplated that the process of receiving an input layer, processing, analyzing, and categorizing the extracted features 302 from the input layer, the hidden layer receiving the input layer for further processing, analysis, and categorizing, and an output layer that receives an output from the hidden layer to produce a final result, may be performed any number of times. The number of times may be dependent on, for example and without limitation, the extracted features 302 received from the user or otherwise.

The LTSM based recurrent network 400, as shown in FIG. 4, may activate a custom process after a prospect has been identified. The LTSM based recurrent network 400 may utilize feedback connections to process data and may connect previous learnings to current opportunities. The use of RNN in combination with the LTSM based recurrent network 400 is contemplated to improve the memory of the system, addressing known deficiencies in RNN systems. The use of RNN is traditionally limited by its ability to retain the extracted features 302 due to a vanishing gradient, resulting in a reduced capability to learn from extracted features 302 as additional extracted features 302 are received.

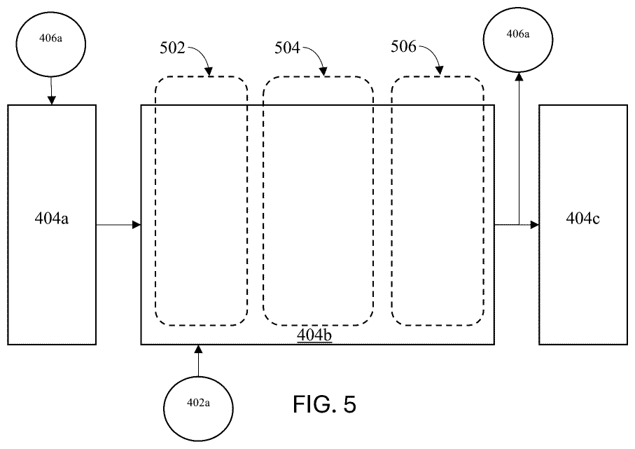

FIG. 5 illustrates an embodiment of a hidden layer of a recurrent neural network. For example, the embodiment illustrated in FIG. 5 may correspond with the hidden layer 404a,b in FIG. 4. As a non-limiting example, data may be received from a previous hidden layer and/or a user input. The neural network, as shown in FIG. 5, may be utilized for learning long-term dependencies. For example, such a neural network may not experience vanishing gradient. Moreover, a cell-state may act as a memory of the neural network. Such a neural network may utilize gates. As a non-limiting example, there may be three gates: a Forget Gate 502, an Input Gate 504, and an Output Gate 506. The Forget Gate 502 may be exploited to forget a value from the cell-state, the Input Gate 504 may be utilized to add and/or update the cell-state, and the Output Gate 506 may be responsible for generating an output from the system.

The data may enter a Forget Gate 502, where the data may be sorted into relevant and irrelevant data. The irrelevant data may comprise data that is not important and may be forgotten. For example, data may be considered not relevant if is not an extracted feature 302, entity, or other similar data. The data may be determined as irrelevant, or not important, if it comprises confidential information, such as protected health information (PHI) and/or personally identifiable identifying information (PII). Of course, the data may be deemed not important or relevant for a variety of reasons, and the aforementioned are provided as non-limiting examples. Forgetting the irrelevant data may not be used for further analysis. For example, the irrelevant data may be forgotten or otherwise removed from the system.

After forgetting irrelevant data, the relevant data may pass from the Forget Gate 502 and enter the Input Gate 504. In an embodiment, the user enters the data directly into Input Gate 504. While in the Input Gate 504, the data may be further processed. The data in the Input Gate 504 may be processed according to any of the methods descried herein such as, for example, the methods described in connection with FIGS. 3 and 4. Of course, other methods of processing may be utilized. Following processing, the data from the Input Gate 504 may be received by the Output Gate 506. In the Output Gate 506, the received data may be further processed, and the further processed data may be sent to a second hidden layer where the aforementioned steps may be performed again. This process may be performed any suitable number of times.

Further, in some embodiments, any of the gates 502/504/506 may be determined according to the client. In one embodiment, the gates 502/504/506 may be utilized to determine what data may be stored in a global model. The global model may be accessible to a plurality of customers. Thus, the gates may transform the data such that it may be utilized without compromising personal and/or confidential information.

It is contemplated that the use of the gates 502/504/506 may filter the data within the system, to reduce the data being processed. Further, the gates 502/504/506 being customized may permit the system to be customized for a variety of purposes, such as use with healthcare. This may further allow the client to tailor the system to their specific needs, such that it can utilize first-party information to generate outputs specific to the client.

In an embodiment of the present disclosure, a data mapper may be created when a user creates a user-supplied list of data points on the Customer-Facing App. The Customer Facing App may read columns from the user-supplied list, which may allow for users to map each column to a data point. A user-supplied column and its relationship with a final column, may be stored in a database. If future users perform the same task as previous users, a mapper_archive table may be queried to find matching columns from the previous user's list. If a match is found, the fields that the previous user chose may be returned.

Further, the user may invoke a request to grade and/or enrich their data via a Data Enrichment Handler. Logic may be implemented to parse a CSV file, and an event with a batch of messages may be posted to a distributed message queuing service (i.e., Amazon SQS) for processing. A batch may be a set of rows from the user-supplied list. An event-driven, serverless computing platform (i.e., AWS Lambda) may listen for new events and may handle new requests. The rows may be passed through the Data Enrichment Handler, which may pass the data through a data processing workflow. If one row of the batch fails, the failed row may be rerun. A grade for the data may not be given unless there has been a data enrichment request. After each data enrichment request, a universally unique identifier (“UUID”) may be created, and said UUID may be passed along to each future step. The original values may be passed along for comparison and grading at the end of the enrichment session. An enriched list may begin with empty values and/or may be configured to fill all columns from an empty set. If a data point cannot be found, a detractor for that row may be created. All rows of the user-supplied list can be iterated over to check for a main URL. If a row's URL field is empty, the Scrape Search Result Page (SERP) may be run.

If no main URL is supplied, then a URL-encoded Google search query may be constructed by utilizing a scraper which may be behind a web-scraping tool (i.e., ScraperAPI) proxy configured to prevent the scraper's Internet Protocol address from being blocked. A source code may be returned from Search Engine Results Pages (“SERP”), and a check may be performed to detect the presence of a Google My Business (“GMB”) listing (or other suitable listing from a management or optimization business profile platform) for a match. If the GMB listing is a match, data, which may include a company's name, phone number, address, and/or URL, may be extracted. Further, if said data has been extracted, the data may be stored as authoritative data points, which may not require further verification. If there is not a GMB listing match, a check of the top ten SERP results may be performed, wherein the authority of the results can be verified. An Authoritative URL Validator may be run on each of the top ten results. The content of each URL may be scraped using a scraper behind the ScraperAPI proxy, which may perform a data check. The data may include a company's name, phone number, and/or address. A regular expression may be run over areas, which may include title tag, meta title and description, and domain name, to verify the authority of the SERP results. If the data cannot be verified, a regex may be run to find matches for the user-supplied data points. A ranking system of the URL's can be created, with verified URL's ranking higher than unverified URL's. If no matches are found, a Secondary Source Parser may be run.

In an embodiment, an Information Extraction (IE) process may be performed. In one embodiment, to read a URL and infer a company name, a candidate may need to be found, and said candidate may be in the form of a named entity which can be labeled “COMPANY_NAME.” Once the named entity has been found from a home page of a company website, the named entity may be transformed into a lowercase format. The domain name may be checked against substring occurrences of the first word of the named entity. If the first word exists within the domain name, an authoritative name of said named entity may be determined. Separate from the Natural Language Processing (NLP) phase of the Main URL Supplied step, an isolated Named Entity Recognition (NER) pipeline may be run on a Title Tag, Meta Title, and Meta Description. A reference to text snippets from the Title Tag, Meta Title, and Meta Description may be stored in a variable for future processing. Specific entities may be searched for within content that is retained. Further, CSS Classnames, Image Filenames, and Anchor Tags may be run separate from the main NLP phase on the isolated NER pipeline. An HTML document can be searched to find predefined CSS Classnames and/or Image Filenames, which may signal the existence of content that does not normally have textual labels. As a non-limiting example, a phone number may be separated from a fax number. A web page may have two numbers without a textual label, and both numbers may be extracted. Once the numbers have been extracted, the CSS Classnames and/or Image Filenames can be used to pinpoint probable regions a phone number is likely to appear in. Moreover, a search for the word “fax” can be performed, and if there are corresponding HTML elements with the same Classnames, then a search within the HTML element may be performed to find a corresponding number. However, if there are no Classnames available, a search for Image Filenames such as “phone,” “number,” “fax,” and “office,” may be performed.

Once the HTML document has been tokenized, for example, when each individual HTML element has been segmented into tokens, or single units, and before the main NER pipeline is ran, all headings and tags may be parsed out. Prior to running the main NER pipeline, an isolated Text Categorizer pipe component may be run, which may label a category of each of the previously found sections such as “AREAS_SERVED_SECTION, LISTING_SECTION, TEAM_SECTION. After the Text Categorizer has been ran, the page segments may be logically separated and identified. Next, the main NER pipeline can be run, and after the membership of a given section may be inferred by performing a check to the closest heading that appeared before the named entity. As a non-limiting example, the previously ran Text Categorizer finds two sections: TESTIMONIAL_SECTION and TEAM_SECTION, and the main NER pipeline may find five PERSON entities. All five PERSON entities may be iterated over, and the nearest section label appearing before said PERSON entity, may be found. In this non-limiting example, the nearest section label appearing before three of the PERSON entities may be TESTIMONIAL_SECTION. As a result, the three PERSON entities may be irrelevant, and may have their labels removed in a post-processing step. The remaining two PERSON entities may have TEAM_SECTION as the nearest section label appearing before them. Consequently, those two PERSON entities may be delivered to the final enriched data.

In an embodiment, to obtain certain enriched fields, secondary sources may need to be parsed, and the data originating from the secondary sources may need to be checked in order of a trust-level. As a non-limiting example, to determine the employee count of a company, the HTML structure of a website such as Linkedin and/or Zoominfo may be parsed, and the information stemming from Linkedin may be trusted more than Zoominfo.

For a grade to be generated, the rows of user-supplied data may be processed one row at a time. The IE process may hold reference to the row's index, as well as the row's original value. As authoritative values are found, the reference to the entity mat be stored. As a non-limiting example, if a phone number is found from the GMB listing, the phone number may be stored as an authoritative phone number. The authoritative values may be compared to the original corresponding value, and if the original value does not match the authoritative value, a score of 0 for that field may be given. Once each column has received a score of 0 and/or 1, the average score of all columns may be calculated, and the average score of the columns may be the final score for the column. When each column receives a score, the average score among all columns may be calculated, which may generate a final score for the list.

An end-user may supply a list of fields and target values to which the end-user may wish an ideal client to conform (ICP). Once the data enrichment has been performed, the end-user's desired ICP value may be compared to the enriched values. If an enriched value matches some or all of the desired ICP values, a score similar to that of the Grade Generator phase may be retained. The processing may occur within an AWS Lambda function, and the function may return an ICP fit score.

In an embodiment of the present disclosure, any of the authoritative data may be stored in a table. The data may include scores, sources, and row indexes for each authoritative data point and/or enriched fields. There may be an enrichment session of the authoritative data which may produce final values for the authoritative data that can be stored in a table. A mapper_archive table may be created, in some embodiments, where previous mapped fields may be stored to suggest future mappings. A user may build an ideal ICP with new fields that may not currently be part of the system. The custom, user-supplied, ICP fields may be associated with an enrichment session. The new user-supplied fields may be stored as icp_fields that may be used in future sessions. An icp_field_industry_association may create associations between an ICP field and compatible industries. Further, the authoritative_data, icp_field_industry_association, and/or mapper_archive table may create new icp_fields. The user-supplied ICP fields and/or the authoritative_data may be used for an enrichment_session. Each enrichment request from the user may be stored. The data from the enrichment_session and/or icp_field_industry_association may flow to an industry, where more industries may be stored as they are added. The data from the enrichment_session may be used for the benefit of the users in an external database and/or customer facing app.

In an embodiment, an Integration Application Programming Interface (API) may serve as a data access layer for an application. The Integration API may perform Create, Read, Update, Delete (CRUD) operations, which can authenticate users of the application. The Integration API may act as a proxy which can interact with third-party API's. As a non-limiting example, the third-party API's may comprise any of Clay, Obviousl.ai, CRMs Salesforce, and/or Hubspot. The application may leverage AWS Cognito for actions such as user sign up, user sign in, and/or control access. A user's access may be based upon a Role-Based Access Control, wherein the user's role may be stored in a database and can be referenced in each user's data. A microservice may use said database to determine what data and/or features users may access.

In an embodiment of the present disclosure, the system may comprise a plurality of subsystems, wherein each subsystem may correspond to a client and/or topic. Each of the subsystems may be provide a microservice, wherein the data received from the client may be used to generate the subsystem, which may comprise any of the characteristics of the system as described herein. For example, each subsystem may comprise at least one database trained according to the methods discussed herein. Any of the system and/or the subsystems may utilize software such as AWS Lambda and API Gateway to facilitate routing and/or processing of data obtained from the client. Of course, other manner for facilitating routing and/or processing of data is contemplated. Furthermore, the system and/or subsystems may be used for business integration. In some embodiments, the system and/or subsystems may be existing software such as Salesforce, Clay, and/or Hubspot.

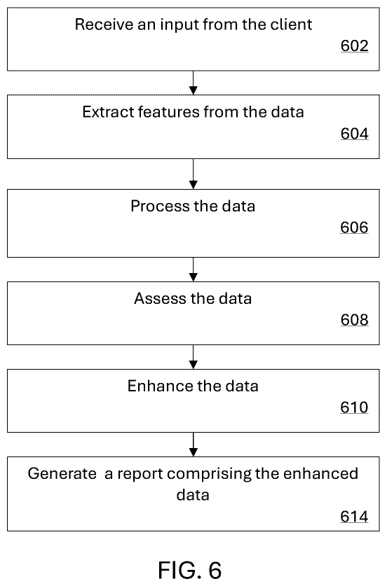

FIG. 6 illustrates a method carried out by the system according to one embodiment. The method may comprise the steps of receiving an input from the client 602, extracting features from the input 604, processing the data 606, assessing the extracted features 608 utilizing a neural network, enhancing the data 610, and generating a report comprising the enhanced data 614 for the client. Steps 602-608 are discussed with reference to FIGS. 3-5 herein. In an embodiment, enhancing the data 610 may be carried out utilized a data refinement workflow. In some embodiments, the method may be initiated upon authenticating a user account. The user account may, in some embodiments, be associated with the client. In order for the system to be accessed, the user must first be authenticated. The user may be authenticated according to any means of authenticating the user, such as a username, password, and, in some embodiments, multi-factor authentication.

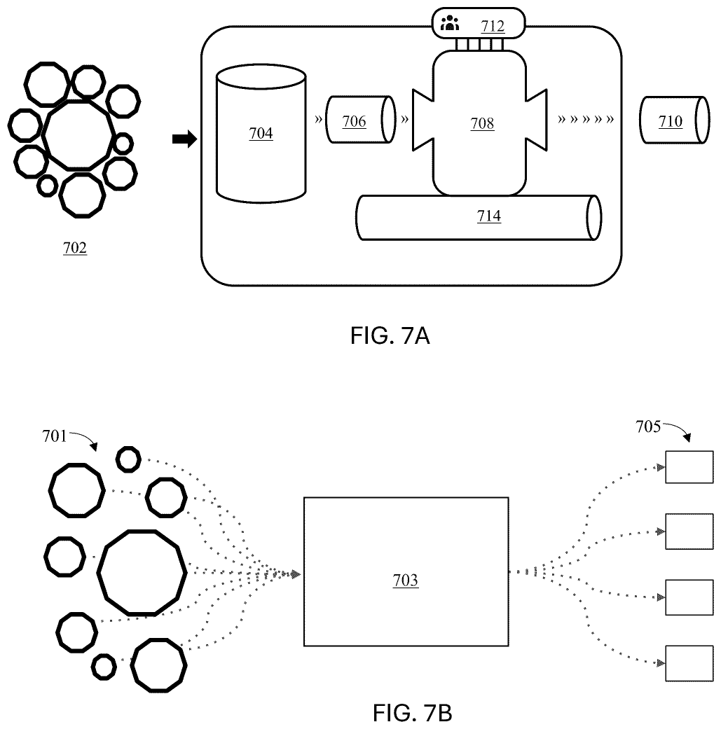

One embodiment of a data refinement workflow for use with raw client data is illustrated in FIG. 7A. The input from the client is illustrated as raw client data 702 which may be processed. The raw client data 702 may first be transformed utilizing a transformation module 704. The transformation module 704 may comprise ingesting the raw client data 702. Ingesting the raw client data 702 may comprise extracting data from the raw client data 702 and/or transforming the raw data 702. Of course, ingesting data is well known in the art and any manner of doing so may be utilized.

The raw client data 702 may be scrubbed to remove any confidential and/or irrelevant information. In some embodiments, this may comprise passing the raw data through the Forget Gate 502 discussed with reference to FIG. 5. However, other means for scrubbing the data may be utilized.

Returning the FIG. 7A, the transformation module 704 may, in some embodiments, further normalize the data. Normalizing the data may be performed in any manner that may be desired, including the manners discussed herein. Further, in some embodiments, the raw client data 702 may be tokenized. Tokenizing may involve breaking the raw client data 702 into smaller portions for processing. For example, tokenizing may be performed using the NER model discussed herein. It is contemplated that tokenizing data may improve the ability of the system to analyze text-based information.

Following the transformation module 704, scrubbed data 706 may be outputted. This scrubbed data may be received by the refinement module 708. In some embodiments, the refinement module 708 may receive an input 712 from the client or other source to provide feedback. In one embodiment, the input 712 may be received via a chatbot interface. The chatbot interface may utilize machine learning algorithms, such as LLMs discussed herein, to interact with the system.

This user input 712 may be utilized to further refine the data. For example, the user input 712 may limit the data that is examined by defining a range of relevant information. Further, in some embodiments, the refinement module 708 may comprise or be in electronic communication with libraries within a data repository 714. In an embodiment, the data repository 714 may comprise third-party libraries, such as FDA, demographic, government, geographic, disease, or other libraries. In other embodiments, the libraries may be first-party libraries. It is contemplated the libraries in the data repository may be determined according to the use of the system.

Another embodiment of data refinement is illustrated in FIG. 7B that may be utilized with unorganized data 701. The unorganized data 701 may, in some embodiments, comprise the refined data 710 extracted in the data refinement workflow illustrated in FIG. 7A. However, in other embodiments, the unorganized data 701 may be directly received from the client, otherwise processed, or any other unorganized data.

The unorganized data 701 may be received by the data refinery 703 where it may be ingested and normalized. Further, the data refinery 703 may receive user input and/or comprise/be in communication with a data repository, as discussed in FIG. 7A. The unorganized data 701 may be refined and an output may be provided. The output 705 may, in some embodiments, be utilized for any of Al technology enhancement, downstream market preparations, evaluating efficiency, and improving internal visibility. Of course, the output 705 may be utilized for other purposes. Indeed, the output 705 is contemplated to be customized to the needs of the client and the use of the output 705 may be customized for the client's purpose.

Refining the data 610 is contemplated to improve the platform's analysis and recognition of data. It is contemplated that refining the data may improve the system's ability to recognize patterns within data, thus improving the system's output to the particular client. Indeed, various clients may share similar data and by refining the data accordingly, the client may further customize the system to the client. Thus, refining the data may provide an improvement to existing technologies by customizing the system and its processing of data to the individual needs and/or data of the client as opposed to the general needs of the population.

Following refining the data 610, a report may be generated comprising the enhanced data 614. In some embodiments, an initial report may be generated prior to enhancing the data 610 and the report comprising the enhanced data may be an updated report. However, in another embodiment, the report comprising the enhanced data may be a unique report.

The report may comprise the enhanced data. The data may be displayed as a graphical representation of the data. The graphical representation may comprise any of a graph, chart, diagram, infographic, plot, illustration, or other graphical representation. In some instances, the enhanced data may be displayed as textual data.

It is contemplated that generating a report according to the methods and systems for processing data as described herein may improve the relevance of the data being displayed.

The systems and methods as described herein may be configured as an open-sourced database for sales-prospecting. Accordingly, the systems and methods described herein may be utilized by actors (i.e., venture backed startups) with sales and fundraising. For example, such actors may struggle to find reliable data feeds based on spam, data quality, wrong identifications, and expensive data sources. Furthermore, applying the systems and methods described to various processes (i.e., sales conversion techniques) may allow for autonomous buyer identification, as well as lowered costs and/or increased margins. Moreover, the systems and methods as described herein may collect and aggregate data in real time. Likewise, autonomous monitoring may be utilized to analyze data and detect problems in addition to predicting future responses. As a result, companies likely to generate prosperous outcomes may be forecasted and said forecasts may be based on a company's digital footprint.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

1. A computer implemented method for sharing and management of first-party data comprising:
authenticating a client account;
receiving an input from the client, wherein the input comprises data to be analyzed;
extracting features from the input, wherein the features correspond to parameters specified by the client;
assessing the extracted features utilizing a neural network, wherein the extracted features are normalized and categorized into various classifications;
generating a report for the client;
receiving a response to the report wherein the response comprises interrogating the report;
responsive to receiving the response to the report, refining the data,
wherein refining the data comprises the steps of:
receiving unorganized data;
receiving in a data refinery the unorganized data, wherein the data refinery is ingested and normalized; and
outputting the refined data; and
responsive to refining the data, updating the report for the client.

2. The method of claim 1, wherein refining the data comprises the steps of:
receiving raw client data;
transforming the raw client data by ingesting the raw client data, scrubbing confidential information from the raw client data, and tokenizing the scrubbed confidential information to refine the data; and
outputting the refined data.

3. The method of claim 2, further comprising receiving on a chatbot interface, a user input to provide feedback to further refine the data.

4. The method of claim 2, wherein the scrubbed confidential information may be refined according to third-party libraries in a data repository.

5. The method of claim 1, wherein the neural network is a Long Short-Term Memory (LSTM) based recurrent neural network.

6. The method of claim 1, wherein the neural network may be trained according to user-specified criteria.

7. A system, comprising at least one processor, at least one database, at least one memory comprising computer-executable instructions which, when executed by the at least one processor, cause the processor to:
authenticate a client account;
receive an input from the client, wherein the input comprises data to be analyzed;
extract features from the input, wherein the features correspond to parameters specified by the client;
assess the extracted features utilizing a neural network, wherein the extracted features are normalized and categorized into various classifications;
generate a report for the client;
receive a response to the report wherein the response comprises interrogating the report;
responsive to receiving the response to the report, refine the data,
wherein the computer-executable instructions, when executed by the at least one processor, further causes the processor to:
receive unorganized data;
receive in a data refinery the unorganized data, wherein the data refinery is ingested and normalized; and
output the refined data; and
responsive to refining the data, update the report for the client.

8. The system of claim 7, wherein the computer-executable instructions which, when executed by the at least one processor, further cause the processor to, when refining the data:
receive raw client data;
transform the raw client data by ingesting the raw client data, scrubbing confidential information from the raw client data, and tokenizing the scrubbed confidential information to refine the data; and
output the refined data.

9. The system of claim 8, wherein the computer-executable instructions which, when executed by the at least one processor, further cause the processor to receive on a chatbot interface, a user input to provide feedback to further refine the data.

10. The system of claim 8, wherein the scrubbed confidential information may be refined according to third-party libraries in a data repository.

11. The system of claim 7, wherein the neural network is a Long Short-Term Memory (LSTM) based recurrent neural network.

12. The system of claim 7, wherein the neural network may be trained according to user-specified criteria.

13. A non-transitory computer readable medium having a set of instructions stored thereon that, when executed by a processing device, cause the processing device to carry out an operation, the operation comprising the steps of:
authenticating a client account;
receiving an input from the client, wherein the input comprises data to be analyzed;
extracting features from the input, wherein the features correspond to parameters specified by the client;
assessing the extracted features utilizing a neural network, wherein the extracted features are normalized and categorized into various classifications;
generating a report for the client;
receiving a response to the report wherein the response comprises interrogating the report;
responsive to receiving the response to the report, refining the data,
wherein refining the data comprises the steps of:
receiving unorganized data;
receiving in a data refinery the unorganized data, wherein the data refinery is ingested and normalized; and
outputting the refined data; and
responsive to refining the data, updating the report for the client.

14. The non-transitory computer readable medium of claim 13, wherein refining the data comprises the steps of:
receiving raw client data;
transforming the raw client data by ingesting the raw client data, scrubbing confidential information from the raw client data, and tokenizing the scrubbed confidential information to refine the data; and
outputting the refined data.

15. The non-transitory computer readable medium of claim 14, further comprising receiving on a chatbot interface, a user input to provide feedback to further refine the data.

16. The non-transitory computer readable medium of claim 14, wherein the scrubbed confidential information may be refined according to third-party libraries in a data repository.

17. The non-transitory computer readable medium of claim 13, wherein the neural network is a Long Short-Term Memory (LSTM) based recurrent neural network.

18. The non-transitory computer readable medium of claim 13, wherein the neural network may be trained according to user-specified criteria.
